(19) United States
(12) Patent Application Publication
(10) Pub. No.: US 2025/0245710 A1
(43) Pub. Date: Jul. 31, 2025

(54) EXIT COMPUTER VISION BASKET MATCHING

(71) Applicant: Walmart Apollo, LLC, Bentonville, AR (US)

(72) Inventors: Feiyun Zhu, Plano, TX (US); Huanyu Zang, Frisco, TX (US); Wei Wang, Dallas, TX (US); Lingfeng Zhang, Flower Mound, TX (US); Mingquan Yuan, Flower Mound, TX (US); Zhaoliang Duan, Frisco, TX (US); Colin Grant Mitchell, Wills Point, TX (US); Yanmei Jin, Dallas, TX (US); William Craig Robinson, Centerton, AR (US)

(21) Appl. No.: 19/036,156

(22) Filed: Jan. 24, 2025

Related U.S. Application Data
(60) Provisional application No. 63/625,771, filed on Jan. 26, 2024.

(51) Int. Cl. G06Q 30/0601; G06V 20/52

(52) U.S. Cl. CPC G06Q 30/0609; G06V 20/52

(57) ABSTRACT

Examples provide a system for exit computer vision basket matching receipts to shopping carts automatically in real-time as a customer is exiting a retail facility. Computer vision analysis of one or more images of a shopping cart produces a set of recognized items from the images. The set of recognized items are compared to the items identified in each candidate receipt in a plurality of candidate receipts. A confidence score is generated for each candidate receipt based on the number of common items found in both the set of recognized items and each receipt. The score is weighted based on factors such as uniqueness of the items and number of instances of each item. The receipt having the highest weighted confidence score is paired with the shopping cart. The paired receipt and image of the shopping cart are output to a user for verification via a user interface.

### BACKGROUND

In retail facilities, items being purchased by customers are typically scanned at a checkout terminal, such as a staffed point-of-sale (POS), a self-checkout (SCO) and/or a scan and go (SNG) checkout. An item identifier (ID), such as a universal product code (UPC), of each scanned item is added to a list of items in a purchase receipt when the transaction is complete. As the customer exits, a store employee may scan the customer receipt along with one or more of the items in the shopping cart to verify whether those items are included in the receipt. This can assist in reducing shrink by identifying inadvertently unscanned items. However, this procedure results in additional friction at store exit for customers and potentially causing a bottleneck for exiting customers. Moreover, this is an inefficient and time-consuming process that results in a negative experience for customers at store exit.

### SUMMARY

Some examples provide a system and method for computer vision basket matching. An image capture device generates image(s) of a selected shopping cart in a retail facility. A computer vision object recognition model identifies a set of one or more recognized items in the shopping cart using the image(s). A basket matching manager compares the set of recognized items with each candidate receipt in the plurality of candidate receipts and calculates confidence scores for each candidate receipts based on a number of items common to the set of recognized items and a candidate set of items identified in each candidate receipt. A candidate receipt having the highest score is selected. The selected receipt is paired with the selected shopping cart. A result is generated that includes the list of items from the selected receipt and one or more images of the selected cart. The result is output to a user via a user interface (UI) for confirmation in real-time as the selected shopping cart is exiting from the retail facility. If confirmation is received, the selected candidate receipt is removed from the pool of candidate receipts.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for computer vision (CV) basket matching using images generated by an exit camera.

FIG. 2 is an exemplary block diagram illustrating a retail facility including a plurality of carts and an exit camera for CV basket matching.

FIG. 3 is an exemplary block diagram illustrating a basket matching manager for CV basket matching.

FIG. 4 is an exemplary block diagram illustrating a plurality of cart images and a plurality of candidate receipts for basket matching.

FIG. 5 is an exemplary block diagram illustrating a process for calculating weighted confidence scores for pairing a receipt with item recognition results for a selected shopping cart.

FIG. 6 is an exemplary flow chart illustrating operation of the computing device to pair a cart to a receipt using CV basket matching.

FIG. 7 is an exemplary flow chart illustrating operation of the computing device to select a candidate receipt for pairing with an image of a cart using confidence scores.

FIG. 8 is an exemplary flow chart illustrating operation of the computing device to select a single cart for pairing to a candidate receipt in a multi-cart receipt match situation.

FIG. 9 is an exemplary flow chart illustrating operation of the computing device to weight a score based on weighting factors, such as uniqueness and item count.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

In the process of completing transactions in a store, some items may inadvertently remain unscanned or unpaid for due to various reasons. As a result, some stores incur significant financial loss every year. An exit camera station can be placed before customers leaving the store where the customer is stopped for a manual audit in which the receipt and various items in the cart are scanned to verify that the items were included in the receipt and capture potential item shrinkage in shopping carts. However, this results in inconvenience to customers.

Customer receipts can be matched with shopping carts via computer vision (CV) based recognition where the camera station captures images of the carts. However, finding the corresponding receipt(s) to the shopping cart in the frame image is a challenging task. Moreover, there could be quite a few receipts that are potential candidates and a large number of unique universal product codes (UPCs) in each receipt.

Referring to the figures, examples of the disclosure enable exit CV basket matching. In some examples, the system generates a candidate receipt-to-cart pairing by comparing items recognized by an item recognition model with each candidate receipt in a plurality of candidate receipts and calculating a confidence score for each proposed receipt-to-cart pairing. This enables more accurate and reliable automatic matching of receipts to customer shopping carts without scanning a customer receipt or creating friction at exit.

In other embodiments, the system generates a plurality of confidence scores associated with a plurality of candidate receipts based on a number of common items included in both the set of recognized items and each candidate set of items identified in each candidate receipt. In this manner, the system provides automatic receipt auditing in real-time without interacting with the customers as they exit the store. This improves customer experience at exit while reducing human time and labor spent manually auditing receipts.

In still other embodiments, the system provides weighted confidence scores used to pair carts with candidate receipts for auditing at exit. The weights are assigned based on weighting factors, such as item uniqueness and item count (frequency). In this manner, more accurate scores are assigned to proposed receipt-to-cart pairings for improved matching of candidate to receipts without human intervention.

In other examples, a receipt-to-cart result is presented to a user via a user interface for audit. During the audit, the user confirms whether items in the paired receipt match items in the paired cart. This enables faster auditing of receipts with reduced processor usage and network bandwidth usage which would otherwise be consumed during manual scanning of receipts and scanning of items in each cart during a manual audit.

The computing device operates in an unconventional manner by providing zero-scan exit CV basket matching with candidate receipts in real-time without interacting with customers as they exit a store. In this manner, the computing device is used in an unconventional way, and allows auditing of receipts in a fast and efficient manner without inconvenience to customers exiting the store or consuming system resources during manual scanning of receipts and items in each customer basket, thereby improving functioning of the underlying computing device.

Other aspects of the system further enable transmission of receipt-to-cart pairs to a user device for use in auditing customer baskets as the customer is exiting the store with their shopping carts. This eliminates the need for scanning receipt barcodes and item barcodes at exit, reducing system memory usage, processor usage and network bandwidth usage. Presenting the results to the user via the user interface further enables improved user efficiency via UI interaction and increased user interaction performance with a reduced error rate in matching receipts to customer carts without human feedback.

In some examples, basket matching enables location of the correct receipt from a large pool of candidate receipts in real-time and plays a significant role in the shrinkage detection, reducing financial loss due to shrinkage. The system can also make a real-time decision as the customer is exiting, enabling a positive customer experience.

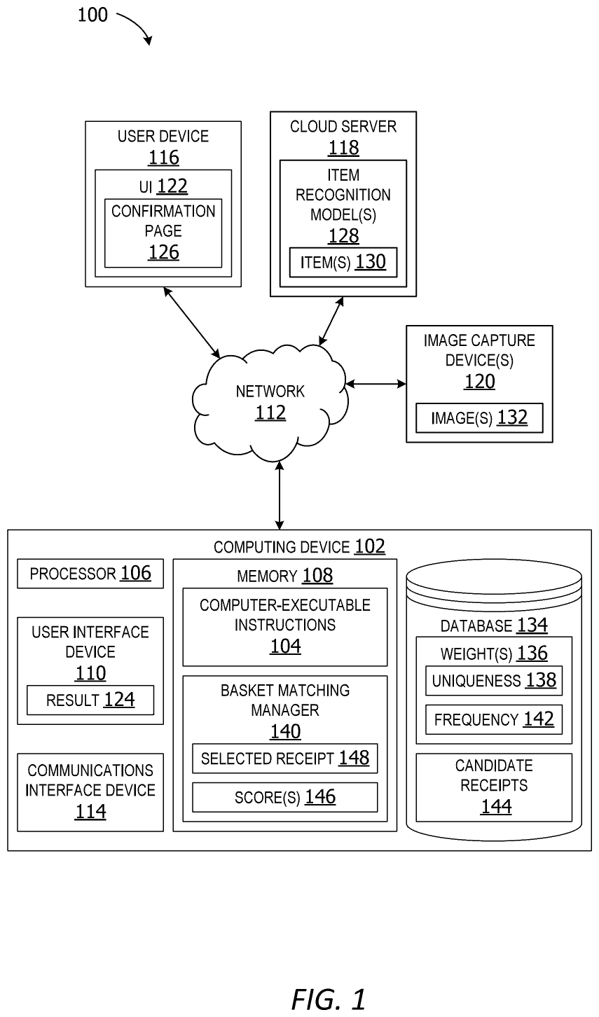

Referring again to FIG. 1, an exemplary block diagram illustrates a system 100 for computer vision basket matching using images generated by an exit camera. Basket matching is used to select the best matched receipt from a candidate pool of receipts. Basket matching, also known as fuzzy matching, is a cost-effective approach to pair exit camera images and corresponding transaction receipt(s). The term “basket” as used herein refers to a shopping cart, shopping basket, or other shopping container and/or the contents within the container. A basket in some embodiments includes a shopping cart and one or more items (products) within the shopping cart.

In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

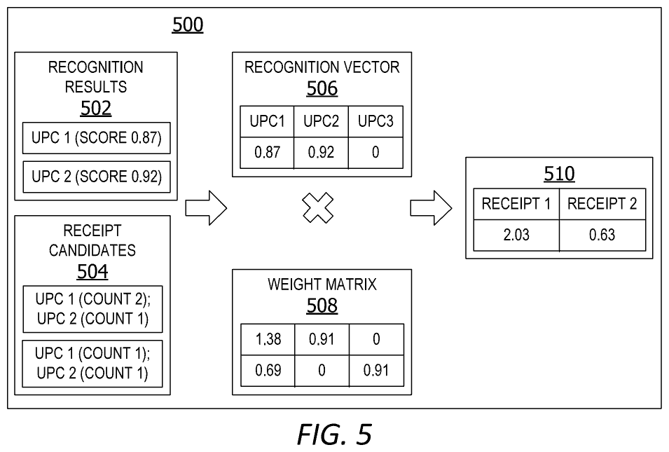

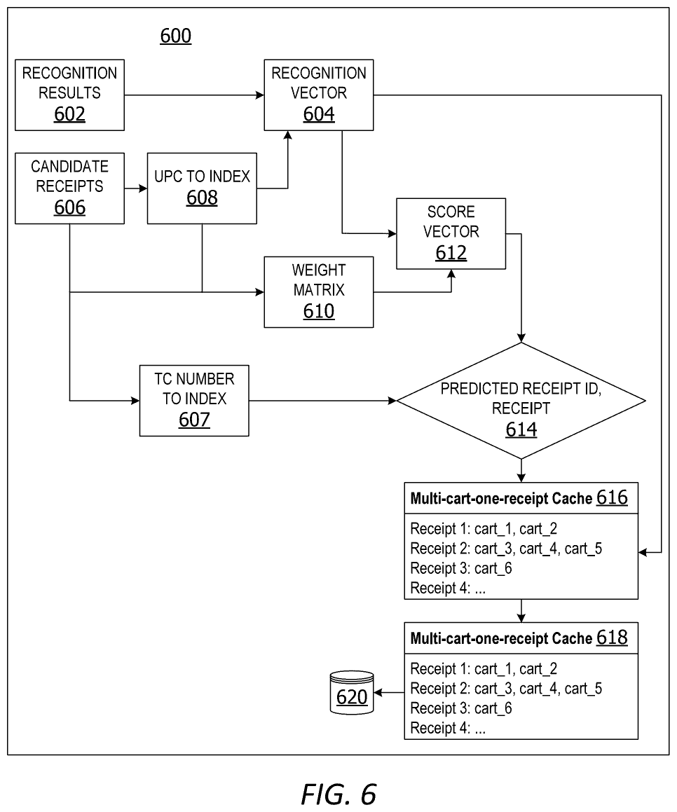

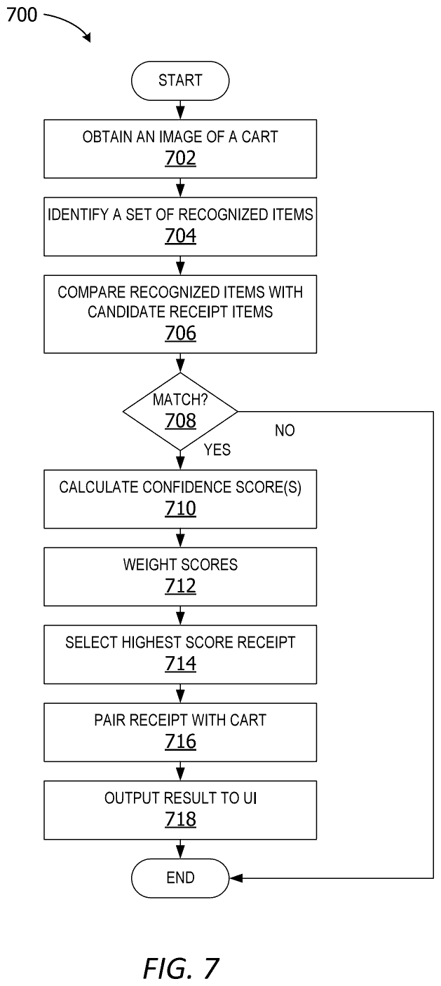

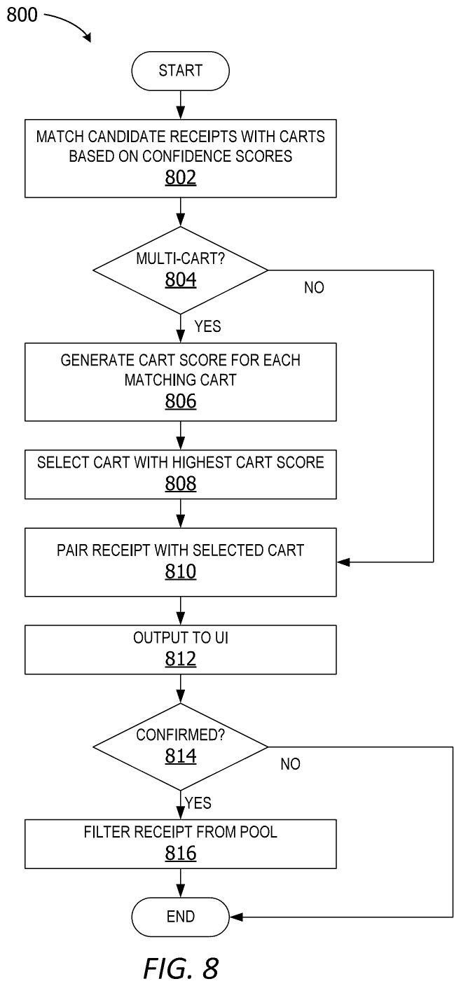

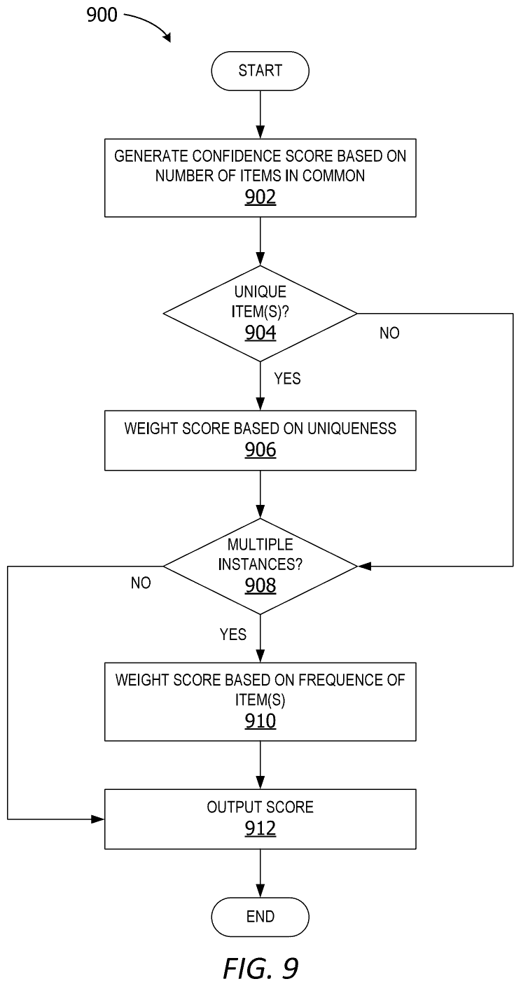

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 5, FIG. 6, FIG. 7, FIG. 8, and FIG. 9).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown).

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to user device 116, cloud server 118, and/or one or more image capture device(s) 120, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) 122 for presenting information to a user, such as, but not limited to, a basket matching result 124 and/or a confirmation page 126.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In this example, the cloud server 118 hosts one or more item recognition model(s) 128. An item recognition model is a computer vision pre-trained convolutional neural network (CNN) item detection and recognition model for identifying objects of interest in one or more image(s) 132 generated by one or more image capture device(s) 120. The item recognition model(s) 128 are trained to detect shopping carts and items in the shopping carts using labeled training data. In this example, the item recognition model(s) 128 include cart detection and recognition models and/or item (product) detection and recognition models. The item recognition model(s) 128 in this example includes a you only look once (YOLO) deep learning model, such as, but not limited to, a YOLO version five (v5) pre-trained object detection model trained on a custom labeled dataset to accurately identify shopping carts and items in the shopping carts in one or more images.

The item recognition model(s) 128 in this example are implemented on the cloud server 118. However, in other embodiments, one or more of the item recognition model(s) 128 are implemented on the computing device 102. The computing device 102 includes a server located within a retail facility or other on-site (local) server.

The item recognition model(s) 128 in some embodiments include one or more classification models. A classification model is a pre-trained machine learning (ML) model for identifying and/or classifying shopping carts in the image(s) 132. The classification model may include pattern recognition or other ML algorithms to analyze the image data associated with the detected carts in the image(s) to label the cart(s) as shopping carts that are currently exiting the retail facility after checking out at a given checkout terminal or other shopping carts which are not currently moving towards a store exit, such as an abandoned (empty) cart. The classification models optionally add annotations to the image data identifying exiting carts and non-exiting carts detected in the image(s) 132.

The one or more image capture device(s) 120 include any type of device for generating one or more digital image(s) 132 of shopping carts located within a field of view (FOV) of the one or more image capture device(s) 120, such as, a camera. The image data associated with the image(s) 132 incudes the image metadata, such as the date and/or time when the image is generated. The image data optionally also includes identification data associated with the image capture device that generated the image.

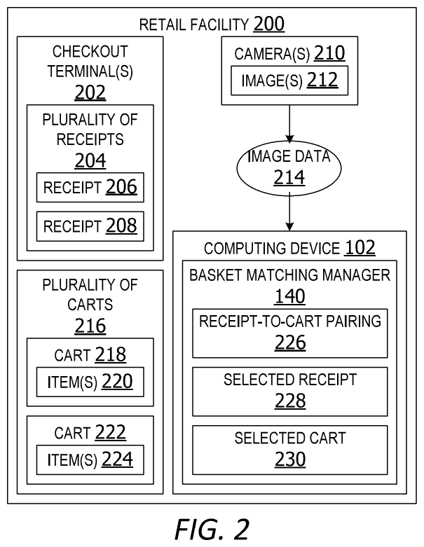

In this example, the image capture device(s) 120 includes an exit camera for generating images of shopping carts which have completed checkout via a checkout terminal and is proceeding toward an exit of a retail facility, such as, but not limited to, the retail facility 200 in FIG. 2. The images generated by a given image capture device optionally generates a series of images of the same shopping cart and the items within the shopping cart or a portion of the shopping cart and a portion of the items in the shopping cart. The image(s) 132 can include color images, black and white images, or any other type of images. In some embodiments, the image(s) 132 include two or more images generated in sequence (in series) as a shopping cart is moving in one direction toward the exit.

In these embodiments, the image(s) 132 do not include images of users or other individuals within the retail facility. Any images having human users or other objects which are not of interest inadvertently included within the images are removed from the images by cropping the images such that only objects of interest remain in the cropped images. Images of users or objects which are not of interest are deleted or otherwise discarded. The cropped images containing only the objects of interest are then analyzed to identify and label the objects of interest within the cropped images, such as, but not limited to, the image(s) 132.

The system 100 can optionally include a data storage device 134 for storing data, such as, but not limited to one or more weight(s) 136 and/or a plurality of candidate receipts 144. The weight(s) 136 include one or more weighting factors, such as, but not limited to, a uniqueness 138 weighting factor and/or a frequency 142 weighting factor. The uniqueness 138 weighting factor refers to whether an item is commonly purchased or whether the item is more unique or rarely purchased. For example, bottles of water, paper towels, and soap are commonly purchased items. However, a big screen television is a unique item which is not typically found on a receipt of items purchased by a customer. Therefore, a television item on a receipt is given a greater weight in scoring the receipt. By leveraging the unique weight assigning algorithm to items (item UPCs) in basket recognition results and receipts, basket matching achieves excellent performance.

Frequency 142 weighting factor refers to the number of instances of an item on a receipt or in a cart. If a cart or receipt includes multiple instances of the same item, that item is given greater weight than if the item occurs only once on the receipt or in the set of recognized item(s) 130 identified by the item recognition model(s) 128.

The data storage device 134 can include one or more different types of data storage devices, such as, for example, one or more rotating disks drives, one or more solid state drives (SSDs), and/or any other type of data storage device. The data storage device 134 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 1xx includes a database.

The data storage device 134 in this example is included within the computing device 102, attached to the computing device, plugged into the computing device, or otherwise associated with the computing device 102. In other examples, the data storage device 134 includes a remote data storage accessed by the computing device via the network 112, such as a remote data storage device, a data storage in a remote data center, or a cloud storage.

The memory 108 in some examples stores one or more computer-executable components, such as, but not limited to, the basket matching manager 140. The basket matching manager 140 is a component that, when executed by the processor 106 of the computing device 102, obtains one or more image(s) 132 of a selected cart including a plurality of items from one or more of the image capture device(s) 120 after checkout as the customer associated with the shopping cart is moving towards the exit. The item recognition model(s) 128 analyze the image(s) 132 to identify the set of one or more recognized item(s) 130 in the image using computer vision object detection and recognition.

The basket matching manager 140, in some embodiments, compares the recognized items with each candidate receipt in a plurality of candidate receipts 144. The basket matching manager 140 calculates confidence score(s) 146 associated with the plurality of candidate receipts based on a number of item IDs associated with a set of common items included in both the set of recognized items and each candidate set of items identified in each candidate receipt. The basket matching manager 140 selects a candidate receipt from the candidate receipts 144 having the highest confidence score. The selected receipt 148 is paired with the image(s) 132 of the selected shopping cart in a receipt-to-cart pairing. The basket matching manager 140 generates a result 124 that includes a list of item IDs corresponding to a set of items identified in the selected receipt 148 with one or more of the image(s) 132 of the selected cart. The result 124 is presented to a user in a confirmation page 126 via the user interface (UI) 122 for confirmation that the selected candidate receipt matches the selected cart. If confirmation is received, the selected receipt is removed from the pool of candidate receipts.

In some embodiments, if confirmation is not received from the user device 116 indicating that the receipt paired with the image(s) 132 is correct, the selected receipt is not removed from the pool of candidate receipts. In such cases, the system optionally prompts the user to manually scan a receipt of the customer associated with the selected shopping cart to perform a manual pairing of a receipt with the images of the cart and/or perform a manual comparison of items in the shopping cart with the items listed in the provided receipt. The provided receipt can include an e-receipt submitted via the customer's user device or a paper receipt printed at the checkout terminal.

The result 124 in this example is presented to a user via the user interface device 110 and/or the UI 122. However, the embodiments are not limited to presenting the results to a user. In other embodiments, the result 124 is transmitted to another software component, computing device or cloud server via the communications interface device 114 for use in confirming a receipt-to-cart pairing prior to customer exit from the store to reduce shrink and improve the customer experience at exit from the retail facility.

In this example, the item recognition model(s) 128 are implemented on the cloud server 118. However, the embodiments are not limited to implementation of these components on the cloud server. In other embodiments, one or more of the item recognition model(s) 128 are implemented on the computing device as part of the basket matching manager 140. In still other embodiments, one or more of the item recognition model(s) 128 are implemented on the computing device 102 with the basket matching manager 140, but remain separate components operating in communication with the basket matching manager 140.

The basket matching manager 140 in this example is implemented on the computing device 102. In this example, the computing device 102 is a local server in the retail facility. However, the basket matching manager 140 in other embodiments is optionally implemented on a remote server which is not located in the retail facility and/or implemented on the cloud server 118.

In some embodiments, all shopping carts detected in the image(s) 132 by the one or more item recognition model(s) 128 are identified as exiting shopping carts which are matched with a candidate receipt. However, in other embodiments, if no items are detected within a shopping cart the basket matching manager designates the cart as a non-exiting cart and does not match a receipt to the cart. In still other examples, if a cart remains immobile for a threshold time-period (amount of time exceeding a user-configurable threshold time period) the system designates the cart as a non-exiting cart. Non-exiting carts are not matched to a candidate receipt.

In this example, the images generated by the image capture device(s) 120 are transmitted to the cloud server 118 and/or the computing device 102 and analyzed in real-time for dynamic basket matching. However, in other examples, the images may be stored in a data storage device, such as, but not limited to, the data storage device 134.

In some embodiments, when a shopping cart appears in the exit camera view of a retail facility, it triggers the item recognition model(s) 128, including an item detection model and an item recognition model. Almost immediately, a list of recognized UPCs (item IDs) is fed into the next stage for basket matching. The system prepares candidate receipts for basket matching. The system uses filtered candidate receipt data, as using all receipts generated during a given day would be redundant and unnecessary. So, the system uses audit information to filter receipts. Those receipts that have already been audited are not treated as candidates.

The basket matching manger in other examples describes all candidate receipts as a matrix, the row number is receipt's index, and the column number is each UPC's index. The basket matching manager 140 describes recognition results as a vector, with fill numbers for each index according to UPC's index and recognized amount of each UPC. The system follows term frequency inverse document frequency (TF-IDF) formula below to assign weights to the receipt matrix. It imports two weight factors. One weighting factor is the number of instances of each item (UPC count). A larger count for an item brings a higher weight. Another weighting factor is uniqueness. A common item UPC does not contribute much on differentiating receipts. The more unique the UPC is, the higher the weight that is assigned to this UPC. The TF-IDF formula is as follows:

$$Term Freq \times log ( 1 + \frac{1 + DocNum}{1 + DocFreq}$$

In some embodiments, the system assigns weights to the recognition vector. The system has different confidence levels for each recognized UPC. The confidence cosine score in the recognition results is used as weight for corresponding UPCs. The multiplication between receipt TF-IDF matrix and recognition vector is conducted to generate a score vector. According to the index of each receipt, this stage generates a matched ID that has the highest score in the vector. If multiple carts are matched to one receipt. To tackle this problem, a Hungarian approach is applied. Common UPCs are used to calculate scores for those multiple carts under this receipt. Only the cart with the highest cart (Hungarian) score is assigned to the receipts. Other receipts in this group are rejected as non-matched. For those carts rejected above, cart-to-cart matching and human-to-human matching are further achieved to find the correct receipt or shopping cart.

Basket matching provides a fast and efficient solution to implement cart to receipt pairing. A real-time result is generated without any human intervention. In-store personnel may take actions immediately as the customer is exiting the store without creating any additional friction at exit or creating any negative customer experience. The candidate receipts can include thousands of unique UPCs and doing one-to-one UPC matching is challenging work. Basket matching implements fuzzy match instead of exact match which highly reduces the heavy workload.

With the power of basket matching, the frame-receipt connections can be built without knowing all UPCs' info in the shopping cart. Manual labelling can also complete the image frame-to-receipt pairing. However, it takes considerable effort to review recognition results and all candidate receipts even under receipt visualization. Moreover, it is unable to meet the “real-time” requirements. Instead of labelling at the backend, the store employee can quickly take actions when shrinkage is detected by basket matching. Thus, the basket matching is more efficient than human (manual) labelling. A UI can still be used verify the correctness of basket matching via the confirmation page 126 presented to the user via the UI 122.

FIG. 2 is an exemplary block diagram illustrating a retail facility 200 including a plurality of carts 216 and an exit camera for CV basket matching. In this example, the retail facility 200 includes one or more camera(s) 210, such as, but not limited to, the image capture device(s) 120 in FIG. 1. The camera(s) 210 generate images 212 of the plurality of carts 216 associated with a plurality of checkout terminals 202. More specifically, the images 212 include images of shopping carts in the plurality of carts 216 which have completed checkout at one or more checkout terminal(s) 202 and are proceeding toward an exit of the retail facility.

The retail facility 200 is a facility such as a brick-and-mortar store. The retail facility 200 can include indoor spaces, outdoor spaces and/or spaces which are partially enclosed and partially unenclosed. The retail facility 200 sells or leases (rents) items (products). The items available for sale or lease can include, for example, grocery items, pet supplies, hardware, toys, clothing (apparel), office supplies, furniture, electronics, health and beauty products, seasonal items, shoes, books, garden supplies, plants, as well as any other types of items.

The plurality of checkout terminal(s) 202 includes one or more checkout terminals for checking out a basket of items during a purchase transaction, such as, but not limited to, a point-of-sale (POS) device staffed by a store employee, a self-checkout (SCO) terminal enabling customer self-checkout, and/or a scan and go (SNG) terminal enabling automated checkout using CV object detection and recognition. The checkout terminal(s) 202 generate a plurality of receipts 204 corresponding to the items in the plurality of carts 216. For each purchase transaction completed at a checkout terminal, a receipt is created, such as, but not limited to, the receipt 206 and/or the receipt 208. Each receipt includes a list of items purchased by a customer. The list of items can include a name of each item and/or an item ID, such as a UPC for the item. The plurality of receipts 204 include receipts associated with e-receipts as well as receipts printed out to a customer on paper (paper receipts). An e-receipt is a receipt which is output to a customer in a digital format, such as a receipt provided in an email or a receipt which can be viewed by a user via an application on a user device.

The one or more camera(s) 210 generates one or more images 212 of each cart in the plurality of carts 216, such as, but not limited to, the cart 218 having one or more item(s) 220 and/or the cart 222 having one or more item(s) 224. Each item in the shopping cart that is scanned at the checkout terminal is included in the list of items on the receipt. In this example, the receipt 206 is generated for the scanned items from the basket of item(s) 220 associated with cart 218 and the receipt 208 is generated for the scanned items in the basket of item(s) 224 associated with cart 222.

In the example of FIG. 2, the camera(s) 210 include one or more exit cameras. In some embodiments, at least one exit camera is mounted to a ceiling or fixture above the floor such that the camera(s) 210 capture a top view (bird's eye view) of each customer basket. In other embodiments, the camera(s) 210 include one or more exit camera is mounted to an arch structure which supports a set of cameras capturing images of shopping carts from multiple angles and views. In this example, multiple cameras mounted to the sides and top of the arch capture images of the sides of the shopping carts, the bottoms of the shopping carts and/or the tops of the shopping carts. In this manner, the images 212 include both side view images of the plurality of carts 216 exiting the store as well as top views of the shopping carts.

The images 212 generated by the camera(s) 210 are transmitted to the basket matching manager 140 on the computing device 102 via a network, such as, but not limited to, the network 112 in FIG. 1. The basket matching manager 140 analyzes the image data 214, item recognition results and candidate receipts to generates scores for each candidate receipt. The basket matching manager generates a receipt-to-cart pairing 226 matching a highest scoring candidate receipt with each cart in the plurality of carts 216 recognized in the images 212. In this example, a selected receipt 228 is paired with a selected cart 230 having the highest confidence score based on the common items found in both the selected cart item recognition results and the list of items provided in the selected receipt 228.

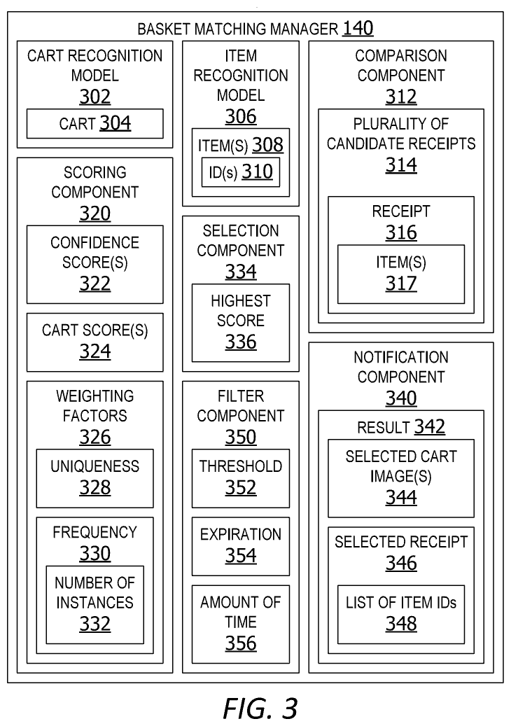

FIG. 3 is an exemplary block diagram illustrating a basket matching manager 140 for CV basket matching. In some embodiments, the basket matching manager 140 includes a cart recognition model 302 which detects shopping carts in images, such as, but not limited to, a cart 304. In this example, the cart recognition model 302 places a bounding box around the cart 304 and/or items in the cart which are captured in the images. The image is optionally cropped to eliminate other objects which are not of interest.

An item recognition model 306 is a pretrained CNN model trained to identify item(s) 308 in a detected cart 304. The item recognition model 306 generates a list of item ID(s) 310 for each item that is identified in the image(s) of the cart 304. The item ID(s) 310 are any type of unique item identifier, such as, but not limited to, a UPC for each item.

A comparison component 312 obtains a plurality of candidate receipts 314 in a pool of unmatched receipts. The receipts in the pool of candidate receipts include receipt data identifying one or more items scanned in a single basket of items at checkout. The receipt data includes data from e-receipts as well as paper receipts generated at checkout by a checkout terminal, such as, but not limited to, the receipt 316 providing a list of item IDs for a list of item(s) 317 purchased by a customer at a checkout terminal. The pool of candidate receipts include receipts which have not yet been paired with a cart and audited by a user.

A scoring component 320 generates one or more confidence score(s) 322 for each candidate receipt in the plurality of candidate receipts 314. Each confidence score indicates a degree of confidence that a given candidate receipt matches a basket of items recognized using the image data for a given cart. The scoring component 320 also optionally generates cart score(s) 324. A cart score is a score assigned to a cart in a set of carts which have all been provisionally matched to the same receipt. This can occur where confidence scores indicate the same receipt could be a best match for two or more carts. In such cases, each cart is given an additional cart score and the cart having the highest score is paired with the candidate receipt.

In some examples, the scoring component 320 utilizes a set of weighting factors 326 to weight the confidence scores and/or the cart scores. The weighting factors are factors used to increase a score for a given receipt-to-cart pairing or decrease the score, such as the weight(s) 136 in FIG. 1. The weighting factors 326 in this example include uniqueness 328 and frequency 330. The uniqueness refers to items which are rarely purchased and/or big ticket items (higher priced items), such as, but not limited to, a big screen television, recliner chair, or other unique item. In this example, items such as bottled water, bread, cleaning wipes, milk, and paper towels are considered non-unique items as they are frequently purchased by customers. Thus, if a receipt-to-cart pairing includes a big screen television identified in the receipt and the recognized items in the cart, this pairing is given a higher confidence score as it is unlikely another customer also purchased a big screen television. The presence of the television increases the likelihood that this is a correct pairing of a receipt with a cart.

The frequency 330 refers to the number of instances 332 of an item. Although bottled water is not a unique item, it can be considered a high frequency item if a single customer purchases three cases of water. Thus, the score for a receipt-to-cart pairing where three cases of bottled water is present would result in a higher score being assigned to the pairing. This higher score reflects the fact that it is unlikely other carts and/or receipts will have three cases of bottled water, so it is more likely that this is a correct basket matching.

A selection component 334 selects a highest score 336 candidate receipt from the plurality of candidate receipts 314 for matching with a selected cart of items. The highest score 336 is a confidence score which is the highest score for a given potential receipt-to-cart match up. The highest score 336 can also refer to a receipt-to-cart match up where both the confidence score and the cart score is the highest score in a plurality of scores generated by the scoring component.

A notification component 340 generates a result 342 including one or more selected cart image(s) 344 and the selected receipt 346 which have been paired together based on the scores. The result 342 includes a list of item IDs 348 for the items in the receipt paired to the cart, such as, a list of item UPCs and/or images of the items in the receipt. The result is transmitted to a UI for viewing by a user for audit. If the user confirms the receipt and cart are correctly paired, the receipt is audited and removed from the pool of candidate receipts available for pairing with other carts. In some examples, the user confirming the receipt-to-cart pairing is stationed near the exit and visually checking whether the list of item IDs 348 in the selected receipt 346 appears to match the items in the selected cart image(s) 344, as well as conforming to the actual shopping cart that is currently exiting the store.

A filter component 350 removes audited receipts from the plurality of candidate receipts 314. In other embodiments, the filter component 350 also removes any candidate receipts which have been in the pool of unmatched candidate receipts for an amount of time 356 which exceeds a user-configurable threshold 352 amount of time, enabling removal of stale receipts after an expiration 354. This prevents stale receipts from remaining in the pool. For example, if a receipt was created at checkout more than twelve hours ago, it is very unlikely that the customer associated with that basket of items has failed to exit the store. Therefore, it is unnecessary to keep that twelve hour old receipt in the pool of candidate receipts used for basket matching. These stale receipts are removed even though they have failed to be matched and audited.

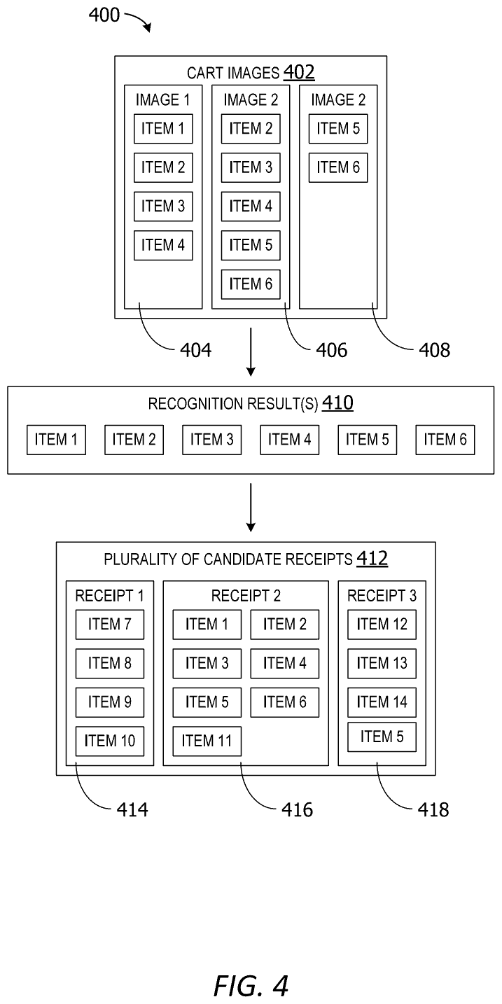

Turning now to FIG. 4, an exemplary block diagram illustrating a plurality of cart images and a plurality of candidate receipts for basket matching process 400 is shown. In this example, the cart images 402 generated by the exit camera(s) include three images. However, the embodiments are not limited to three images. In other embodiments, the cart images 402 can include a single image of a cart, two images of a cart, as well as four or more images of a cart.

The first image 404 in this example includes four items in the selected cart. The second image 406 includes five items in the selected cart. The third image 408 includes only two items visible within the image. The three images include a total of six unique items. The CV item recognition result(s) 410 generated by the trained CNN item detection and recognition model(s) include these six unique items. The items in the recognition result(s) 410 for the selected cart are compared with the sets of items in each candidate receipt in the plurality of candidate receipts 412 currently in the pool of unmatched receipts. In this example, the plurality of candidate receipts 412 includes three receipts. However, the embodiments are not limited to three candidate receipts. In other embodiments, the plurality of candidate receipts includes any number of candidate receipts. For example, the plurality of candidate receipts can include a single receipt, two receipts, as well as four or more receipts. In some examples, the plurality of candidate receipts includes dozens of receipts, hundreds of receipts or even thousands of receipts.

In this example, the first candidate receipt 414 includes no items in common with the items in the recognition result(s) 410. This receipt-to-cart pairing receives a very low confidence score. The second candidate receipt 416 includes six items in common with the recognition result(s) 410 and only one item which is not found in the recognition result(s) 410. The second candidate receipt 416 receives a very high score based on the number of common items identified in both the selected cart and the candidate receipt. The third candidate receipt 418 has only a single item in common with the recognition result(s) 410. The third candidate receipt 418 receives a score which is slightly higher than the first candidate receipt 414 but which is significantly lower than the second candidate receipt 416. In this example, the second receipt has the highest score and is matched with the selected cart associated with the recognition result(s) 410.

FIG. 5 is an exemplary block diagram illustrating a process 500 for calculating weighted confidence scores for pairing a receipt with item recognition results for a selected shopping cart. The process 500 shown in FIG. 5 is performed by a basket matching manager component, executing on a computing device, such as the computing device 102 or the user device 116 in FIG. 1.

In this example, recognition results 502 are generated by item recognition model(s), such as, but not limited to, the item recognition model(s) 128 in FIG. 1 and/or the item recognition model 306 in FIG. 3. The recognition results 502 include a UPC for a first item (UPC1) and a second item (UPC2). The receipt candidates 504 include one or more candidate receipts, such as, but not limited to, the one or more candidate receipts 144 in FIG. 1, the plurality of candidate receipts 314 in FIG. 3, and/or the plurality of candidate receipts 412 in FIG. 4. Each UPC receives a confidence score. The candidate receipts in this example include a first receipt having two instances of the item corresponding to UPC1 and a single instance of the item with the UPC2. The candidate receipts also include a second candidate receipt having a single instance of the item with UPC1 and a single instance of the item with the UPC2.

The basket matching component generates a recognition vector 506 for the recognition results 502 and a weight matrix 508 used to weight the scores for each potential receipt-to-cart pairing. The final weighted scores 510 for each receipt indicates that the first receipt is the highest scoring receipt and predicted to be the most likely match with the recognition results 502 of the selected cart.

In this example, the first receipt is paired with the selected cart for confirmation by a user at audit. During audit, in some cases, a human user reviews the items in the matched receipt and the images of the selected cart and indicates whether the match is correct or incorrect. In one example, the user looks at the selected cart to visually verify that the items in the cart match the items in the matched receipt. If a match is not made, the user may stop the customer and request to scan the customer's receipt. At this time, the user may scan one or more items in the customer's cart to verify the items in the cart match the items in the receipt provided by the customer. The provided receipt can be an e-receipt or a paper receipt.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to pair a cart to a receipt using CV basket matching. The process 600 shown in FIG. 6 is performed by a basket matching manager component, executing on a computing device, such as the computing device 102 or the user device 116 in FIG. 1.

In this example, a recognition vector 604 is generated based on recognition results 602 for a selected cart. The UPCs in one or more candidate receipts 606 are indexed at 608. A total count (TC) number to index is optionally created in some examples. The TC number to index 607 includes the total number of items included in each receipt.

A weight matrix 610 is created and used to weight the confidence scores generated based on a score vector 612. A predicted receipt ID 614 for a candidate receipt having the highest score is selected from a plurality of candidate receipts available in cache.

In some examples, multiple carts are potentially matched to a single receipt, as shown in the multi-cart-one-receipt cache 616. If multiple carts are matched to a single receipt, cart scores are generated and used to identify the cart in the set of carts matched to the same receipt which is predicted to be the best match. A single receipt is matched to a single cart, as shown in the one cart to one receipt match 618. The receipt-to-cart pairing results are stored in a database 620. The database 620 is associated with a data storage device, such as, but not limited to, the data storage device 134 in FIG. 1.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to select a candidate receipt for pairing with an image of a cart using confidence scores. The process 700 shown in FIG. 7 is performed by a basket matching manager component, executing on a computing device, such as the computing device 102 or the user device 116 in FIG. 1.

The process begins by obtaining an image of a cart at 702. The cart is a cart in a plurality of carts exiting a store, such as, but not limited to, the plurality of carts 216 in FIG. 2. An item recognition model identifies a set of recognized items at 704. The basket matching manager compares the recognized items with candidate receipt items at 706. A determination is made whether any candidate receipts are available to match with the selected cart at 708. If yes, one or more confidence score(s) are generated at 710. The scores are weighted at 712. The weighting is performed using weighting factors, such as, but not limited to, the weighting factors 326 in FIG. 3. The highest score receipt is selected at 714. The selected receipt is paired with the cart at 716. The result is output to a UI at 718. The UI is a user interface, such as, but not limited to, the user interface device 110 in FIG. 1 and/or the UI 122 in FIG. 1.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

Referring now to FIG. 8, an exemplary flow chart illustrating operation of the computing device to select a single cart for pairing to a candidate receipt in a multi-cart receipt match situation is shown. The process 800 shown in FIG. 8 is performed by a basket matching manager component, executing on a computing device, such as the computing device 102 or the user device 116 in FIG. 1.

The process begins by matching candidate receipts with carts based on confidence scores at 802. A decision is made whether multiple carts are matched with a single receipt at 804. If yes, a cart score is generated for each matching cart at 806. The cart with the highest cart score is selected at 808. The receipt is paired with the selected cart at 810. The receipt-to-cart pairing is output to a UI at 812. The UI is a user interface, such as, but not limited to, the user interface device 110 in FIG. 1 and/or the UI 122 in FIG. 1. A determination is made whether confirmation is received from a user at 814. The confirmation is provided during an audit of the matched receipt. If confirmed, the audited receipt is filtered from the pool of candidate receipts at 816. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 is an exemplary flow chart illustrating operation of the computing device to weight a score based on weighting factors, such as uniqueness and item count. The process 900 shown in FIG. 9 is performed by a basket matching manager component, executing on a computing device, such as the computing device 102 or the user device 116 in FIG. 1.

The process begins by generating a confidence score based on a number of items in common at 902. A determination is made whether one or more item(s) are unique at 904. If yes, the score is weighted based on uniqueness at 906. A determination is made whether multiple instances of items are present in the recognized items and/or the candidate receipt at 908. If yes, the score is weighted based on frequency of the item(s) at 910. The score is option output at 912. In some embodiments, the score is output to a selection component selecting the highest scoring receipt for pairing with the cart. In other examples, the score is output with the receipt-to-cart pairing result to a user. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

### Additional Examples

In some embodiments, basket matching with computer-vision object detection and recognition enables zero-scan exit that directly improves basket verification performance and customer experience. When a customer is passing exit camera(s), a CV model generates a list of recognized item UPCs in the cart. Basket matching is used to locate the correct receipt corresponding to the cart from a large number of candidate receipts efficiently and accurately in a very short time.

Basket matching, also known as fuzzy matching, compares object detection and recognition results with each candidate receipt in a plurality of receipts. A score is calculated based on a set of UPCs common to both the cart and the receipt(s). The best matched receipt is selected without knowing all the UPCs in the shopping cart, so it is called “fuzzy” matching.

In an example scenario, when a shopping cart appears in the exit camera view, it triggers the detection and recognition model. Almost immediately, a list of recognized UPCs is fed into the next stage for basket matching. Preparing candidate receipts for basket matching is the next step. Retrieving all receipts from a single day is redundant and unnecessary. Instead, the system uses audit information to filter receipts which have already been matched to a cart. Those receipts that have already been matched and audited are not treated as candidates. Instead, they are removed from the pool of candidate receipts.

In some embodiments, all candidate receipts are described as a matrix. The row number is the receipt's index. The column number is each UPC's index. The item detection and recognition results are described as a vector with fill numbers for each index according to UPC's index and recognized amount of each UPC.

In other embodiments, the system follows TF-IDF formula to assign weights to the receipt matrix. It imports two weight factors. One is UPC count which provides a higher weight to a receipt having one or more items in a higher (larger) count. Another weighting factor is uniqueness. An item UPC which commonly appears in receipts does not contribute too much on differentiating receipts. However, a unique item which only rarely appears on a customer receipt (more unique) is given a higher weight due to this unique UPC.

In still other embodiments, weights are also assigned to the item recognition results vector. Models have different confidence levels on each recognized UPC. The confidence cosine score in recognition results is used as a weight for corresponding item UPCs. The multiplication between receipt TF-IDF matrix and recognition vector is conducted to generate a score vector. According to the index of each receipt, this stage generates a matched ID that has the highest score in the vector.

In some embodiments, multiple carts are matched to one receipt. To tackle this problem, common UPCs are used to calculate cart scores for each cart in those multiple carts matched with the same receipt. Only the cart with the highest cart score is assigned to the receipt. Other receipts in this group are rejected as non-matched. For those carts rejected above, cart-to-cart matching and human-to-human matching are further achieved to find the correct receipt or shopping cart.

In yet other embodiments, the system provides computer vision based basket matching for automatically pairing items detected in a basket/shopping cart by CV object detection with a correct receipt in a retail store in real-time. The system includes a camera that captures images of the basket or shopping cart when the customer is exiting a store. The system identifies unique product codes (UPC) of the products identified in the captured images. The system retrieves all unaudited receipts to match the basket with the most appropriate receipt. The receipts are given individual scores based on products matched in each receipt. The scores are assigned based on two weight factors. UPC count-larger count of a product brings higher weight. Uniqueness-More unique UPC is higher weight is assigned to it. If multiple carts are matched to one receipt, the cart with the highest cart (Hungarian) score is assigned to the receipt. Common UPCs are used to calculate scores for those multiple carts under this receipt.

In an example, a set of frames are captured by the exit camera, and CV results are generated by classification & verification models. The system obtains a list of candidate receipts in a certain time window that have not been audited yet. The system assigns different weights based on confidence score, count, frequency, etc. for each UPC. The system calculates the score for each receipt, selects the one receipt that has the highest score, and assigns the receipt ID to current shopping cart. Multiple carts may be matched to one receipt; when it happens, select the receipt with the highest Hungarian (cart) score and reject the others.

Alternatively, or in addition to the other examples described herein, examples include any combination of the following:
obtain, from the image capture device, a plurality of images of the selected cart captured in series, wherein the set of recognized items are identified using the plurality of images, and wherein the image capture device is an exit camera associated with a checkout terminal;
add a weight to each confidence score in the plurality of confidence scores using a set of weighting factors, wherein the set of weighting factors comprises a uniqueness factor, wherein a higher weight is assigned to items having a higher degree of uniqueness;
add a weight to each score in the plurality of confidence scores using a set of weighting factors, wherein the set of weighting factors comprises an item count factor, wherein a higher weight is assigned to items having a higher count value;
responsive to matching a plurality of carts to a candidate receipt, generate a cart score for each cart in the plurality of carts, the cart score indicating a degree of confidence a given cart matches a given receipt based on a number of items common to both the given cart and the given receipt, a frequency of occurrence of each item in common, and a uniqueness of each item in common;
pair the candidate receipt with the cart in the plurality of carts having a highest cart score;
responsive to receiving confirmation that the selected candidate receipt is correctly paired with the selected cart, remove the selected candidate receipt from the plurality of candidate receipts, wherein the selected candidate receipt removed from the plurality of candidate receipts is an audited receipt;
wherein the plurality of candidate receipts includes unaudited receipts generated within a threshold maximum time-period;
filter receipts from the plurality of candidate receipts generated outside the maximum time-period;
obtaining an image of a selected cart including a plurality of items from an image capture device subsequent to checkout;
identifying a set of recognized items in the image by a computer vision item recognition model;
comparing the set of recognized items with each candidate receipt in a plurality of candidate receipts;
calculating a plurality of confidence scores associated with the plurality of candidate receipts based on a number of item IDs associated with a set of common items included in both the set of recognized items and each candidate set of items identified in each candidate receipt;
selecting a candidate receipt from the plurality of candidate receipts having a highest score in the plurality of confidence scores;
pairing the selected candidate receipt with the selected cart;
generating a result comprising a list of item IDs corresponding to a set of items identified in the selected candidate receipt with the image of the selected cart, wherein the result is presented to a user via a user interface (UI) device for confirmation that the selected candidate receipt matches the selected cart;
generating, from the image capture device, a plurality of images of the selected cart captured in series, wherein the set of recognized items are identified using the plurality of images, and wherein the image capture device is an exit camera associated with a checkout terminal;
weighting each score in the plurality of confidence scores using a set of weighting factors, wherein the set of weighting factors comprises a uniqueness factor, wherein a higher weight is assigned to a unique item, wherein the unique item is an item having a lower number of instances of the item sold within a predetermined time period;
weighting each score in the plurality of confidence scores using a set of weighting factors, wherein the set of weighting factors comprises an item count factor, wherein a higher weight is assigned to items having a higher count value;
matching a plurality of carts to a candidate receipt based on the plurality of confidence scores, wherein the highest confidence score is assigned to each cart in the plurality of carts;
generating a cart score for each cart in the plurality of carts, the cart score indicating a degree of confidence a given cart matches a given receipt based on a number of items common to both the given cart and the given receipt, a frequency of occurrence of each item in common, and a uniqueness of each item in common;
pairing the candidate receipt with the cart in the plurality of carts having a highest cart score;
receiving confirmation from the UI device that the selected candidate receipt is correctly paired with the selected cart;
removing the selected candidate receipt from the plurality of candidate receipts, wherein the selected candidate receipt removed from the plurality of candidate receipts is an audited receipt;
filtering a set of audited receipts from the plurality of candidate receipts;
filtering a set of expired receipts from the plurality of candidate receipts, wherein an expired receipt is a receipt generated outside a user-configurable threshold maximum time-period;
obtaining, from the image capture device, a plurality of images of the selected cart generated in series within a predetermined time-period, wherein the set of recognized items are identified using the plurality of images, and wherein the image capture device is an exit camera associated with a checkout terminal;
adding a higher weight to each confidence score in the plurality of confidence scores using a set of weighting factors, wherein the set of weighting factors comprises a uniqueness factor for a unique item present in the set of recognized items and the candidate set of items, wherein the unique item is an item having a lower number of instances of the item sold within a predetermined time period;
adding a weight to each confidence score in the plurality of confidence scores using a set of weighting factors, wherein the set of weighting factors comprises an item count factor, wherein a higher weight is assigned to item IDs having a higher count value;
responsive to receiving confirmation from the UI device that the selected candidate receipt is correctly paired with the selected cart, removing the selected candidate receipt from the plurality of candidate receipts, wherein the selected candidate receipt removed from the plurality of candidate receipts is an audited receipt;
responsive to receiving a rejection from the UI device indicating the selected candidate receipt is incorrectly paired with the selected cart, returning the selected candidate receipt to the plurality of candidate receipts;
identify an amount of time since creation of a candidate receipt; and
filter the candidate receipt responsive to the amount of time since creation exceeding a threshold maximum amount of time.

At least a portion of the functionality of the various elements in FIG. 1, FIG. 2 and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some examples, the operations illustrated in FIG. 5, FIG. 6, FIG. 7, FIG. 8, and FIG. 9 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of CV based basket matching, the method comprising identifying a set of recognized items in an image of a selected cart by a computer vision item recognition model, the selected cart comprising a plurality of items; comparing the set of recognized items with each candidate receipt in a plurality of candidate receipts; calculating a plurality of confidence scores associated with the plurality of candidate receipts based on a number of item IDs associated with a set of common items included in both the set of recognized items and each candidate set of items identified in each candidate receipt; weighting each confidence score in the plurality of confidence scores in accordance with a set of weighting factors associated with item count and item uniqueness of each item common to both the set of recognized items and the candidate set of items of each candidate receipt in the plurality of candidate receipts; selecting a candidate receipt from the plurality of candidate receipts having a highest weighted confidence score in the plurality of confidence scores; pairing the selected candidate receipt with the selected cart; and generating a result comprising a list of item IDs corresponding to a set of items identified in the selected candidate receipt with the image of the selected cart, wherein the result is presented to a user via a user interface (UI) device for confirmation that the selected candidate receipt matches the selected cart.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for exit CV basket matching. For example, the elements illustrated in FIG. 1, FIG. 2, and FIG. 3, such as when encoded to perform the operations illustrated in FIG. 5, FIG. 6, FIG. 7, FIG. 8, and FIG. 9, constitute exemplary means for obtaining an image of a selected cart including a plurality of items from an image capture device subsequent to checkout; exemplary means for identifying a set of recognized items in the image by a computer vision item recognition model; exemplary means for comparing the set of recognized items with each candidate receipt in a plurality of candidate receipts; exemplary means for calculating a plurality of confidence scores associated with the plurality of candidate receipts based on a number of item IDs associated with a set of common items included in both the set of recognized items and each candidate set of items identified in each candidate receipt; exemplary means for selecting a candidate receipt from the plurality of candidate receipts having a highest score in the plurality of confidence scores; exemplary means for pairing the selected candidate receipt with the selected cart; and exemplary means for generating a result comprising a list of item IDs corresponding to a set of items identified in the selected candidate receipt with the image of the selected cart, wherein the result is presented to a user via a user interface (UI) device for confirmation that the selected candidate receipt matches the selected cart.

Other non-limiting examples provide one or more computer storage devices having a first computer-executable instructions stored thereon for providing exit CV basket matching. When executed by a computer, the computer performs operations including obtaining an image of a selected cart including a plurality of items from an image capture device subsequent to checkout; identifying a set of recognized items in the image by a computer vision item recognition model; comparing the set of recognized items with each candidate receipt in a plurality of candidate receipts; calculating a plurality of confidence scores associated with the plurality of candidate receipts based on a number of item IDs associated with a set of common items included in both the set of recognized items and each candidate set of items identified in each candidate receipt; selecting a candidate receipt from the plurality of candidate receipts having a highest score in the plurality of confidence scores; pairing the selected candidate receipt with the selected cart; and generating a result comprising a list of item IDs corresponding to a set of items identified in the selected candidate receipt with the image of the selected cart, wherein the result is presented to a user via a user interface (UI) device for confirmation that the selected candidate receipt matches the selected cart.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for computer vision basket matching, the system comprising:
a processor;
an image capture device generating images of a plurality of carts; and
a computer-readable medium storing instructions that are operative upon execution by the processor to:
analyze an image of a selected cart from the images generated by the image capture device by a computer vision (CV) object recognition model in real-time, the selected cart including a plurality of items;
identify a set of recognized items in the image by a computer vision item recognition model;
analyze the set of recognized items with each candidate receipt in a plurality of candidate receipts, wherein a candidate receipt includes a set of scanned item identifiers (IDs) associated with a set of scanned items;
calculate a plurality of confidence scores associated with the plurality of candidate receipts based on a number of items common to the set of recognized items and a candidate set of items identified in each candidate receipt;
identify a candidate receipt from the plurality of candidate receipts having a highest score in the plurality of confidence scores;
pair the selected candidate receipt with the selected cart; and
generate a result comprising a list of item IDs corresponding to a set of items identified in the selected candidate receipt with the image of the selected cart, wherein the result is presented to a user via a user interface (UI) device for confirmation that the selected candidate receipt matches the selected cart.

2. The system of claim 1, wherein the instructions are further operative to:
obtain, from the image capture device, a plurality of images of the selected cart captured in series, wherein the set of recognized items are identified using the plurality of images, and wherein the image capture device is an exit camera associated with an exit.

3. The system of claim 1, wherein the instructions are further operative to:
add a weight to each confidence score in the plurality of confidence scores using a set of weighting factors, wherein the set of weighting factors comprises a uniqueness factor, wherein a higher weight is assigned to items having a higher degree of uniqueness.

4. The system of claim 1, wherein the instructions are further operative to:
add a weight to each score in the plurality of confidence scores using a set of weighting factors, wherein the set of weighting factors comprises an item count factor, wherein a higher weight is assigned to items having a higher count value.

5. The system of claim 1, wherein the instructions are further operative to:
responsive to matching a plurality of carts to the candidate receipt, generate a cart score for each cart in the plurality of carts, the cart score indicating a degree of confidence a given cart matches a given receipt based on the number of items common to both the given cart and the given receipt, a frequency of occurrence of each item in common, and a uniqueness of each item in common; and
pair the candidate receipt with the cart in the plurality of carts having a highest cart score.

6. The system of claim 1, wherein the instructions are further operative to:
responsive to receiving the confirmation that the selected candidate receipt is correctly paired with the selected cart, remove the selected candidate receipt from the plurality of candidate receipts, wherein the selected candidate receipt removed from the plurality of candidate receipts is an audited receipt.

7. The system of claim 1, wherein the plurality of candidate receipts includes unaudited receipts generated within a threshold maximum time-period, and wherein the instructions are further operative to:
filter receipts from the plurality of candidate receipts generated outside the maximum time-period.

8. A method for computer vision basket matching, the method comprising:
obtaining an image of a selected cart including a plurality of items from an image capture device;
identifying a set of recognized items in the image by a computer vision item recognition model;
comparing the set of recognized items with each candidate receipt in a plurality of candidate receipts;
calculating a plurality of confidence scores associated with the plurality of candidate receipts based on a number of item IDs associated with a set of common items included in both the set of recognized items and each candidate set of items identified in each candidate receipt;
selecting a candidate receipt from the plurality of candidate receipts having a highest score in the plurality of confidence scores;
pairing the selected candidate receipt with the selected cart; and
generating a result comprising a list of item IDs corresponding to a set of items identified in the selected candidate receipt with the image of the selected cart, wherein the result is presented to a user via a user interface (UI) device for confirmation that the selected candidate receipt matches the selected cart.

9. The method of claim 8, further comprising:
generating, from the image capture device, a plurality of images of the selected cart captured in series, wherein the set of recognized items are identified using the plurality of images, and wherein the image capture device is an exit camera associated with an exit.

10. The method of claim 8, further comprising:
weighting each score in the plurality of confidence scores using a set of weighting factors, wherein the set of weighting factors comprises a uniqueness factor, wherein a higher weight is assigned to a unique item, wherein the unique item is an item having a lower number of instances of the item sold within a predetermined time period.

11. The method of claim 8, further comprising:
weighting each score in the plurality of confidence scores using a set of weighting factors, wherein the set of weighting factors comprises an item count factor, wherein a higher weight is assigned to items having a higher count value.

12. The method of claim 8, further comprising:
matching a plurality of carts to the candidate receipt based on the plurality of confidence scores, wherein the highest confidence score is assigned to each cart in the plurality of carts;
generating a cart score for each cart in the plurality of carts, the cart score indicating a degree of confidence a given cart matches a given receipt based on a number of items common to both the given cart and the given receipt, a frequency of occurrence of each item in common, and a uniqueness of each item in common; and
pairing the candidate receipt with the cart in the plurality of carts having a highest cart score.

13. The method of claim 8, further comprising:
receiving the confirmation from the UI device that the selected candidate receipt is correctly paired with the selected cart; and
removing the selected candidate receipt from the plurality of candidate receipts, wherein the selected candidate receipt removed from the plurality of candidate receipts is an audited receipt.

14. The method of claim 8, further comprising:
filtering a set of audited receipts from the plurality of candidate receipts; and
filtering a set of expired receipts from the plurality of candidate receipts, wherein an expired receipt is a receipt generated outside a user-configurable threshold maximum time-period.

15. One or more computer storage devices having computer-executable instructions stored thereon, which, upon execution by a computer, cause the computer to perform operations comprising:
identifying a set of recognized items in an image of a selected cart by a computer vision item recognition model, the selected cart comprising a plurality of items;
comparing the set of recognized items with each candidate receipt in a plurality of candidate receipts;
calculating a plurality of confidence scores associated with the plurality of candidate receipts based on a number of item IDs associated with a set of common items included in both the set of recognized items and each candidate set of items identified in each candidate receipt;
weighting each confidence score in the plurality of confidence scores in accordance with a set of weighting factors associated with item count and item uniqueness of each item common to both the set of recognized items and the candidate set of items of each candidate receipt in the plurality of candidate receipts;
selecting a candidate receipt from the plurality of candidate receipts having a highest weighted confidence score in the plurality of confidence scores;
pairing the selected candidate receipt with the selected cart; and
generating a result comprising a list of item IDs corresponding to a set of items identified in the selected candidate receipt with the image of the selected cart, wherein the result is presented to a user via a user interface (UI) device for confirmation that the selected candidate receipt matches the selected cart.

16. The one or more computer storage devices of claim 15, wherein the operations further comprise:
obtaining, from an image capture device, a plurality of images of the selected cart generated in series within a predetermined time-period, wherein the set of recognized items are identified using the plurality of images, and wherein the image capture device is an exit camera associated with an exit.

17. The one or more computer storage devices of claim 15, wherein the operations further comprise:
adding a higher weight to each confidence score in the plurality of confidence scores using the set of weighting factors, wherein the set of weighting factors comprises a uniqueness factor for a unique item present in the set of recognized items and the candidate set of items, wherein the unique item is an item having a lower number of instances of the item sold within a predetermined time period.

18. The one or more computer storage devices of claim 15, wherein the operations further comprise:
adding a weight to each confidence score in the plurality of confidence scores using the set of weighting factors, wherein the set of weighting factors comprises an item count factor, wherein a higher weight is assigned to item IDs having a higher count value.

19. The one or more computer storage devices of claim 15, wherein the operations further comprise:
responsive to receiving the confirmation from the UI device that the selected candidate receipt is correctly paired with the selected cart, removing the selected candidate receipt from the plurality of candidate receipts, wherein the selected candidate receipt removed from the plurality of candidate receipts is an audited receipt; and
responsive to receiving a rejection from the UI device indicating the selected candidate receipt is incorrectly paired with the selected cart, returning the selected candidate receipt to the plurality of candidate receipts.

20. The one or more computer storage devices of claim 15, wherein the operations further comprise:
identify an amount of time since creation of a candidate receipt; and
filter the candidate receipt responsive to the amount of the time since the creation exceeding a threshold maximum amount of time.
